(19) United States
(12) Patent Application Publication
(10) Pub. No.: US 2018/0269827 A1
(43) Pub. Date: Sep. 20, 2018

(54) PARALLEL-CONNECTED SOLAR POWER CONVERTER SYSTEM

(71) Applicant: BEIJING SINBON TONGAN ELECTRONICS CO., LTD., Beijing (CN)

(72) Inventor: Kangrui Gong, Beijing (CN)

(21) Appl. No.: 15/609,230

(22) Filed: May 31, 2017

(30) Foreign Application Priority Data
Mar. 14, 2017 (CN) 201720245903.5

(51) Int. Cl. H02S 40/32

(52) U.S. Cl. CPC H02S 40/32

(57) ABSTRACT

A parallel-connected solar power converter system includes a master AC (Alternating Current) trunk line, multiple parallel-connected power inverters and multiple connection devices. The master AC trunk line has multiple parallel connection nodes. Each power inverter has a power input terminal and a power output terminal. The power input terminal is electrically connected to a solar panel. The connection device has a first connector and a second connector. The first connector is connected to the master AC trunk line and is electrically connected to a corresponding parallel connection node. The second connector is electrically connected to the power output terminal of a corresponding power converter, is detachably connected to the first connector, and is electrically connected to the corresponding parallel connection node. Accordingly, the parallel-connected solar power converter system is easy in installation, and has a low contact resistance with operational stability not affected by any faulty power inverter.

### BACKGROUND OF THE INVENTION

### 1. Field of the Invention

The present invention relates to a parallel-connected system and, more particularly, to a parallel-connected solar power converter system.

### 2. Description of the Related Art

With reference to FIG. 7, a conventional series-connected solar power converter system includes multiple solar panels 60 and multiple power inverters 70. Each power inverter 70 has a first AC (Alternating Current) connector 71, a second AC connector 72, and a DC (Direct Current) connector 73. The DC connector 73 is electrically connected to one of the multiple solar panels 60. The first AC connector 71 of one of adjacent two of the multiple power converters 70 is connected to the second AC connector 72 of the other power converter 70 for the two adjacent power converters 70 to be connected in series. Each power inverter 70 receives DC power generated by a corresponding power panel 60 and converts the DC power into AC power. As the multiple power inverters 70 are sequentially connected in series, the DC power generated by the multiple power inverters 70 is collected as a whole and the collected DC power is sequentially transmitted out through the first AC connectors 71 and the second AC connectors 72 of the multiple power converters 70.

However, the conventional series-connected solar power converter system has the following problems.

1. Each power inverter 70 has two AC connectors, namely, the first AC connector 71 and the second AC connector 72. When users intend to install the multiple power inverters 70, each power inverter 70 has to make two connections with the first AC connector 71 and the second AC connector 72, thus causing more time consumed in installation of the power inverters 70.

2. Generally, when two connectors are connected, an electrical contact point is formed and has a contact resistance. As each power inverter 70 is connected in series between another two power inverters 70 adjacent to the power inverter 70, because of connection of the first AC connector 71 and the second AC connector 72, each power inverter 70 has two contact points and the total contact resistance of the contact points of the multiple power inverters 70 becomes a negative factor against power-generating efficiency.

3. In view of the series-connected power inverters 70, when any power inverter 70 is faulty, the circuit loop for power generation is disconnected to result in the loss of overall power generation function of the series-connected solar power converter system.

4. As each power inverter 70 has two AC connectors and AC connector is usually costly, the material cost in building the series-connected solar power converter system is still high.

### SUMMARY OF THE INVENTION

An objective of the present invention is to provide a parallel-connected solar power converter system capable of resolving the issues of conventional series-connected solar power converter systems by connecting the power inverters to a master AC (Alternating Current) trunk line through a connection device of the parallel-connected solar power converter system.

To achieve the foregoing objective, the parallel-connected solar power converter system has a master AC trunk line, multiple power inverters and multiple connection devices.

The master AC trunk line has multiple parallel connection nodes.

Each power inverter has a power input terminal and a power output terminal. The power output terminal is electrically connected to a solar panel.

Each connection device is parallelly connected between a corresponding parallel connection node and the power output terminal of a corresponding power inverter for the multiple power inverters to be parallelly connected. Each connection device has a first connector and a second connector.

The first connector is connected to the master AC trunk line and is electrically connected to the corresponding parallel connection node.

The second connector is electrically connected to the power output terminal of the corresponding power inverter, is detachably connected to the first connector, and is electrically connected to the corresponding parallel connection node.

The present invention has the following advantages:

1. By virtue of the connection device, the first connector and the second connector can be easily and rapidly connected and detached to overcome the time-consuming issue in installation of conventional technique.

2. In contrast to conventional technique that each power inverter requires two connectors for connection with adjacent power inverters or each power inverter has two contact resistances because of two contact points, the present invention only requires one second connector in connection with the first connector of the master AC trunk line, such that each power inverter only has one contact resistance because only one contact point exists, resulting in less contact points and less contact resistance, and in turn high power-generating efficiency. Thus, the issue of high contact resistance in the conventional technique can be overcome.

3. The power inverters of the present invention are connected in parallel with the master AC trunk line. Hence, when any power inverter is faulty, the faulty power inverter will not hinder the entire power generation function of the solar power converter system. The remaining normal power inverters can still transmit power out through the master AC trunk line. The issue of power breakdown in the conventional technique because of any faulty power inverter can thus be overcome.

4. Unlike the conventional technique, each power inverter in the present invention has only one second connector in connection with the first connector of the master AC trunk line, such that the number of necessary connector in the present invention can be reduced. Thus, the material cost can be lowered and the higher cost issue in the conventional technique arising from more connectors required can be overcome.

Other objectives, advantages and novel features of the invention will become more apparent from the following detailed description when taken in conjunction with the accompanying drawings.

### BRIEF DESCRIPTION OF THE DRAWINGS

FIG. 1 is a schematic view of a parallel-connected solar power converter system in accordance with the present invention;

FIG. 2 is a perspective view showing wiring connection of a connection device of the parallel-connected solar power converter system in FIG. 1;

FIG. 3 is an exploded perspective view showing wiring connection of the connection device in FIG. 2;

FIG. 4 is a perspective view of the connection device in FIG. 2;

FIG. 5 is a partial top view of the connection device in FIG. 2;

FIG. 6 is a perspective view showing isolation fasteners used in the connection device in FIG. 2; and

FIG. 7 is a conventional series-connected solar power converter system.

### DETAILED DESCRIPTION OF THE INVENTION

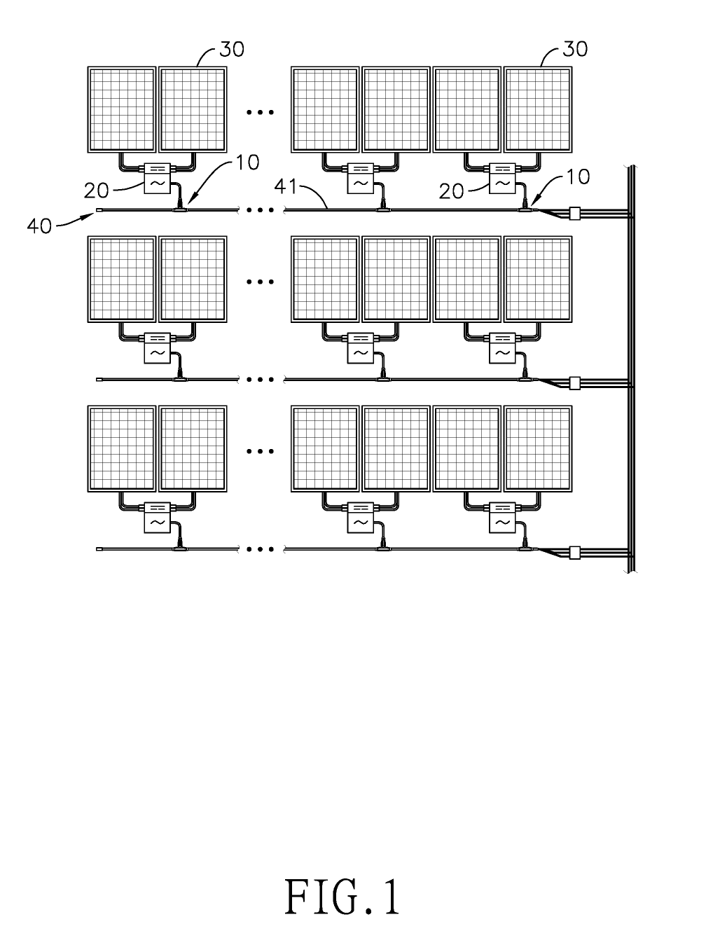

With reference to FIG. 1, a parallel-connected solar power converter system in accordance with the present invention includes multiple connection devices 10, multiple power inverters 20, multiple solar panels 30 and a master AC (Alternating Current) trunk line 40. The master AC trunk line 40 is connected to the multiple power inverters 20 and the multiple solar panels 30.

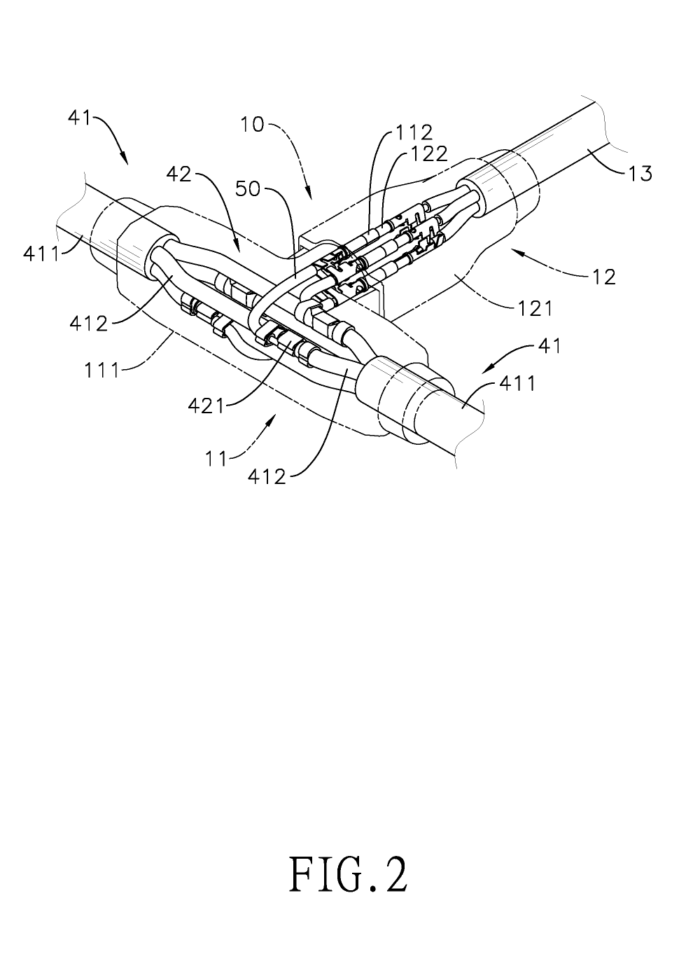

With reference to FIGS. 1 and 2, the master AC trunk line 40 has multiple connection cables 41 and multiple parallel connection nodes 42. The multiple parallel connection nodes 42 are connected in a way that one of the multiple connection cables 41 is connected between each adjacent two of the multiple parallel connection nodes 42. Each connection cable 41 may be an electrical cable and has an outer sheath 411 and multiple electrical wires 412 wrapped around by the outer sheath 411 and mounted through the outer sheath 411 in a longitudinal direction. End portions of the electrical wires 412 of each connection cable 41 are exposed beyond the outer sheath 411. The multiple electrical wires 412 serve to transmit AC power. Each electrical wire 412 has a conductor and a cable insulation sheathing the conductor.

Each parallel connection node 42 has multiple electrical couplers 421 connected to the respective electrical wires 412 of a corresponding connection cable 41. Each electrical coupler 421 is electrically connected between the conductor of a corresponding electrical wire 412 of one of the multiple connection cables 41 and the conductor of a corresponding electrical wire 412 of another connection cable 41 adjacent to the connection cable 41. In the present embodiment, each electrical coupler 421 is a metal crimped joint.

The multiple power inverters 20 correspond to the respective parallel connection nodes 42. Each power inverter 20 has one or multiple power input terminals and one power output terminal with each power input terminal connected to a corresponding solar panel 30, receives DC power generated by the corresponding solar panel 30, converts the DC power into AC power, and outputs the AC power through the power output terminal.

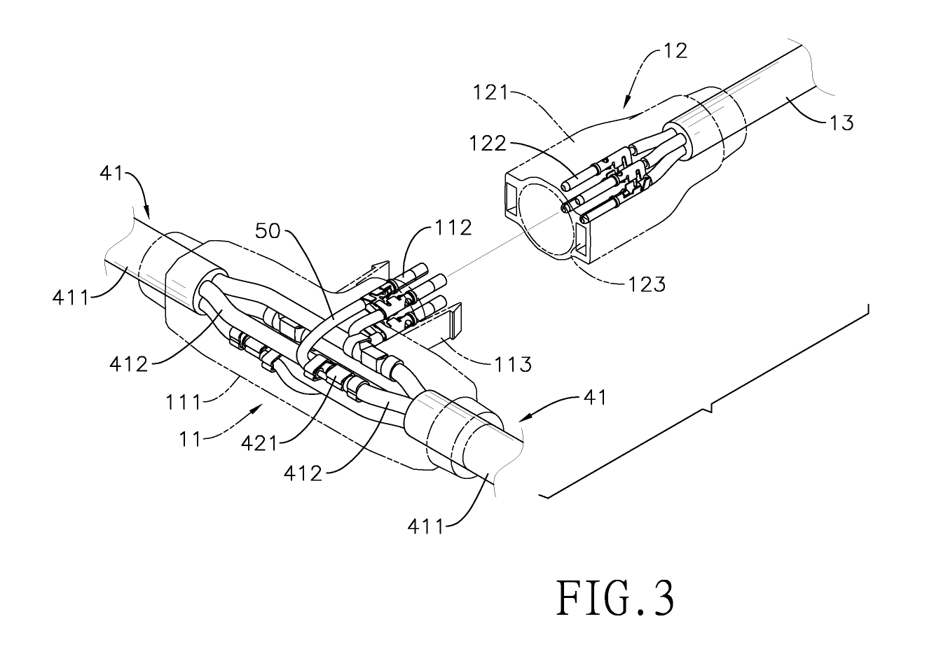

With reference to FIGS. 2 and 3, each connection device 10 is parallelly connected between a corresponding parallel connection node 42 and the power output terminal of a corresponding power inverter 20, such that the multiple power converters 20 can be parallelly connected. The connection device 10 has a first connector 11 and a second connector 12. The first connector 11 is connected to the master AC trunk line 40 and is electrically connected to the corresponding parallel connection node 42. The second connector 12 is electrically connected to the power output terminal of the corresponding power inverter 20, is detachably connected to the first connector 11, and is electrically connected to the corresponding parallel connection node 42.

With reference to FIGS. 2 to 4, the first connector 11 has a first housing 111 and multiple first electrical connection elements 112. The first housing 111 may be made of plastic, and encloses a corresponding parallel connection node 42 and the end portions of the electrical wires 412 exposed beyond the outer sheaths 411 of two corresponding connection cables 41. The multiple first electrical connection elements 112 may be metal tubings, are mounted in the first housing 111, protrude beyond an opening formed through a peripheral side wall of the first housing 111, and are electrically connected to the electrical couplers 421 of the corresponding parallel connection node 42. Alternatively, the first electrical connection elements 112 are electrically connected to the electrical coupler 421 of the corresponding parallel connection node 42 through electrical cables 50. It is noted that the two electrical wires 412 and the first electrical connection elements 112 connected to each electrical coupler 421 transmits power with identical phase.

The second connector 12 has a second housing 121 and multiple second electrical connection elements 122. The second housing 121 may be made of plastic. The multiple second electrical connection elements 122 may be metal insert fitted into the respective metal tubings, are mounted in the second housing 121, and are exposed from an open end of the second housing 121. When the first connector 11 and the second connector 12 are connected, the multiple second electrical connection elements 122 are electrically connected to the respective first electrical connection elements 112. It is noted that each first electrical connection element 112 and each second electrical connection element 122 are used to transmit power with identical phase.

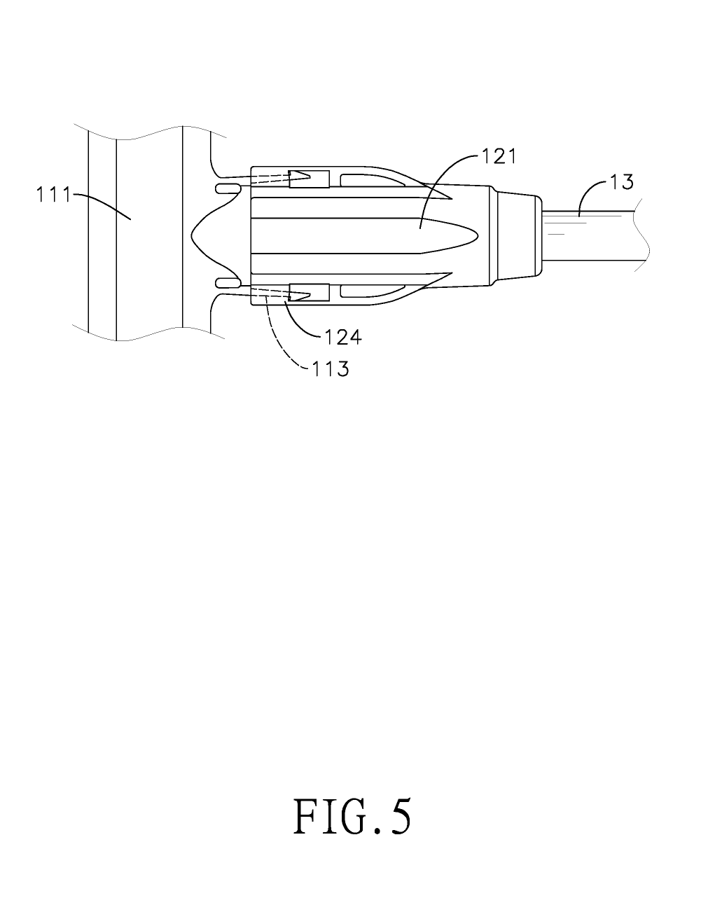

With reference to FIGS. 3 and 5, the first housing 111 has two arms 113 formed on the peripheral side wall of the first housing 111 and oppositely located beside the opening. Each arm 113 has a barbed end. The second housing 121 has two insertion holes 123 and two retaining blocks 124. The two insertion holes 123 are aligned with the respective arms 113. Each retaining block 124 is for wed on an inner wall of a corresponding insertion hole 123. When the first connector 11 is connected with the second connector 12, the arms 113 are inserted into the respective insertion holes 123 and the barbed ends of the arms 113 are elastically bent to engage the retaining blocks 124 of the respective insertion holes 123. Meanwhile, the multiple second electrical connection elements 122 are connected to the respective first electrical connection elements 112. When the first connector 11 is detached from the second connector 12, the arms 113 are pressed for the barbed ends of the arms 113 to disengage from the respective retaining blocks 124, such that the first connector 11 and the second connector 12 can be separated.

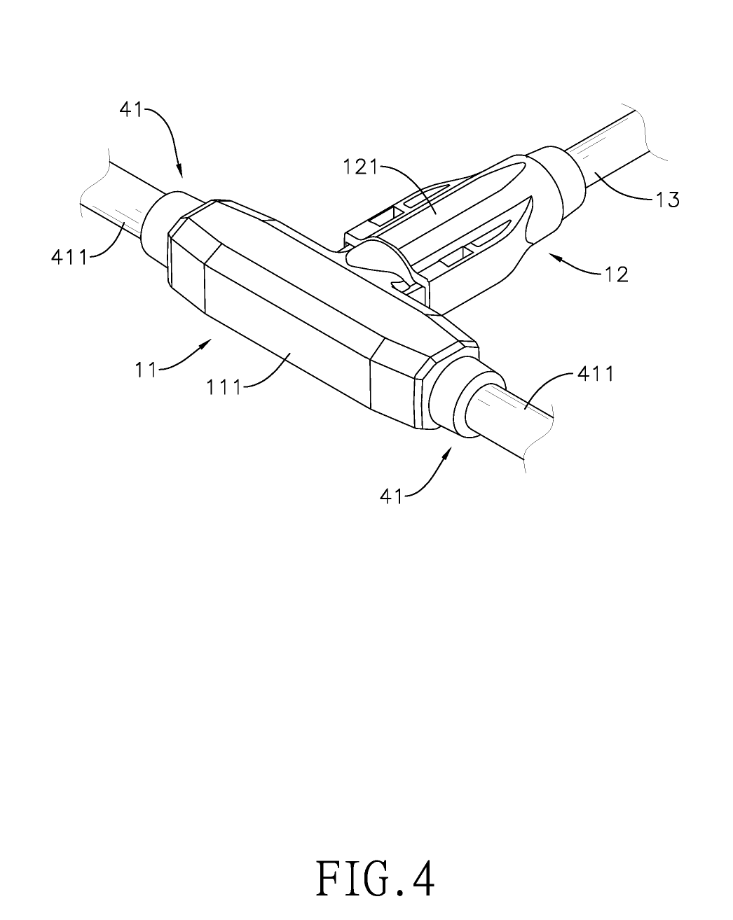

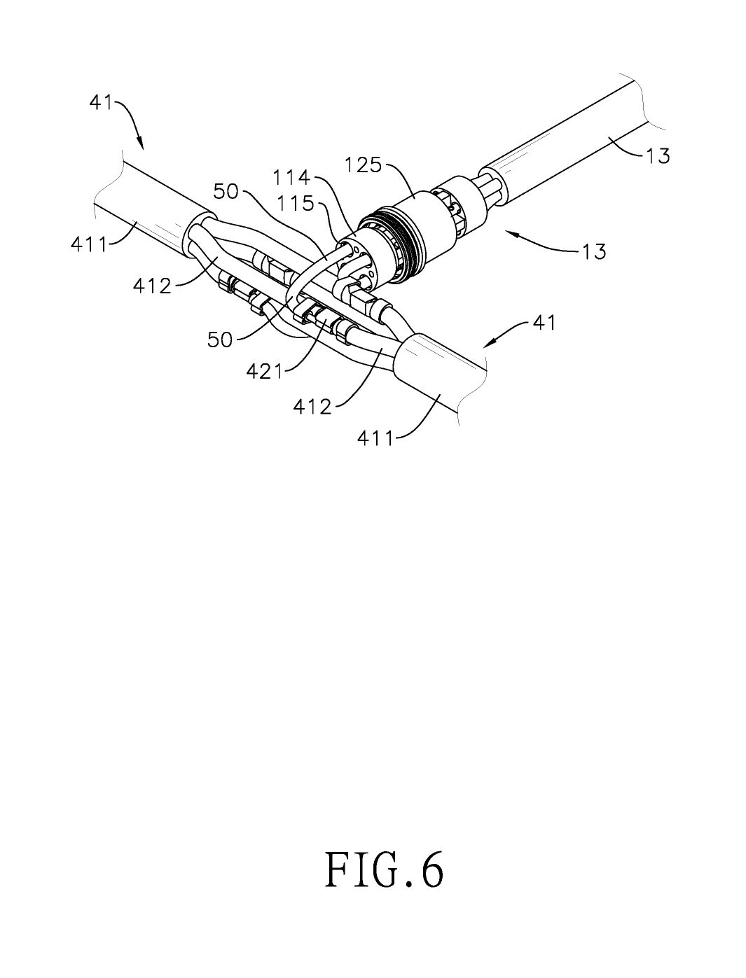

With reference to FIG. 6, the first connector 11 includes a first isolation fastener 114 mounted inside the first housing 111 as shown in FIG. 4. The first isolation fastener 114 may be made of plastic and is electrically insulating, and has multiple first channels 115 through which the multiple first electrical connection elements 112 are mounted. Likewise, the second connector 12 includes a second isolation fastener 125 mounted inside the second housing 121 as shown in FIG. 4. The second isolation fastener 125 may be made of plastic and is electrically insulating, and has multiple second channels through which the multiple second electrical connection elements 122 are mounted. By virtue of the first isolation fastener 114 and the second isolation fastener 125, the multiple first electrical connection elements 112 and the second electrical connection elements 122 can be isolated and fastened, thereby enhancing safety of stability of the parallel-connected solar power converter system.

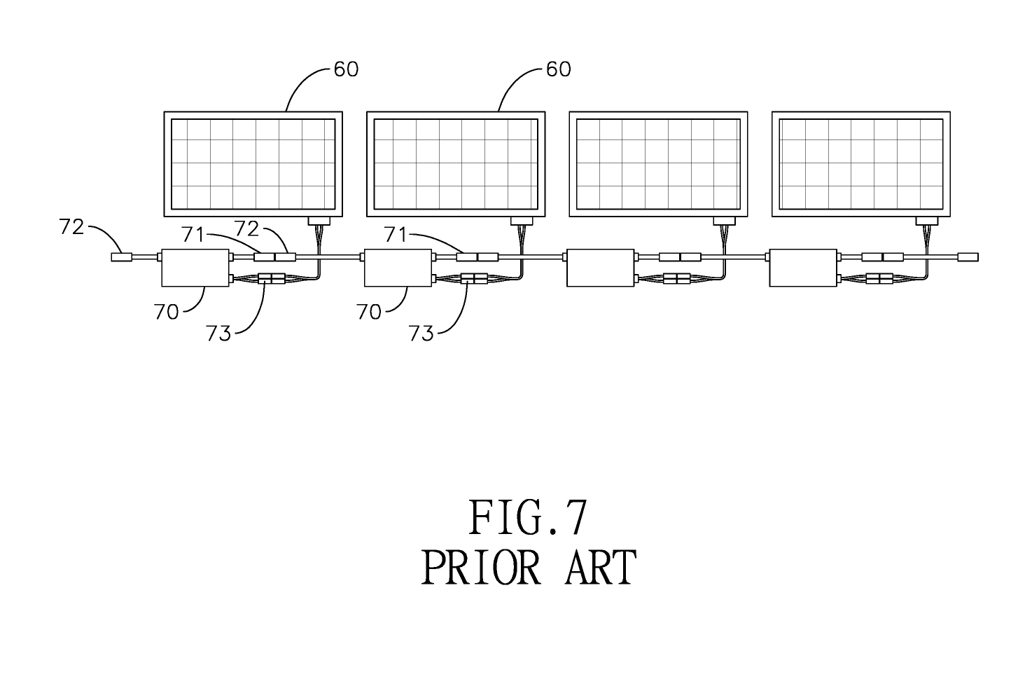

In sum, given the connection device 10, users can rapidly and conveniently connect and detach the first connector 11 and the second connector 12 to shorten the installation of the parallel-connected solar power converter system. The conventional series-connected solar power converter system in FIG. 7 requires two AC connectors for each power inverter 70 to be connected to adjacent power inverters 70. In other words, each power inverter 70 corresponds to two contact points. However, each power inverter 20 in the present invention only corresponds to one contact point. In contrast to the conventional technique, the number of the contact points required by the present invention is reduced. Such reduction in turn leads to a lower contact resistance and a higher power-generating efficiency of the entire solar power converter system. Moreover, as the multiple power inverters 20 are parallelly connected to the master AC trunk line 40, when any power inverter 20 is faulty, the faulty power inverter 20 will not affect overall power-generating function of the parallel-connected solar power converter system because other normally operating power inverters 20 can still supply power through the master AC trunk line 40. Additionally, unlike the conventional technique requiring two AC connectors for each power inverter 70 to be connected to adjacent power inverters 70, each power inverter 20 in the present invention only requires one second connector 12 to be connected to a corresponding first connector on the master AC trunk line 40. The reduction in the number of the connector also leads to saving of material and cost-down of the entire solar power converter system.

Even though numerous characteristics and advantages of the present invention have been set forth in the foregoing description, together with details of the structure and function of the invention, the disclosure is illustrative only. Changes may be made in detail, especially in matters of shape, size, and arrangement of parts within the principles of the invention to the full extent indicated by the broad general meaning of the terms in which the appended claims are expressed.

What is claimed is:

1. A parallel-connected solar power converter system, comprising:
a master AC (Alternating Current) trunk line having multiple parallel connection nodes;
multiple power inverters, each power inverter having a power input terminal and a power output terminal, wherein the power output terminal is electrically connected to a solar panel; and
multiple connection devices, each connection device parallelly connected between a corresponding parallel connection node and the power output terminal of a corresponding power inverter for the multiple power inverters to be parallelly connected, and having:
a first connector connected to the master AC trunk line and electrically connected to the corresponding parallel connection node; and
a second connector electrically connected to the power output terminal of the corresponding power inverter, detachably connected to the first connector, and electrically connected to the corresponding parallel connection node.

2. The parallel-connected solar power converter system as claimed in claim 1, wherein
the first connector has:
a first housing enclosing the corresponding parallel connection node; and
multiple first electrical connection elements mounted in the first housing and electrically connected to the corresponding parallel connection node; and
the second connector has:
a second housing; and
multiple second electrical connection elements mounted in the second housing, and electrically connected to the respective first electrical connection elements and the power output terminals of the respective power inverters.

3. The parallel-connected solar power converter system as claimed in claim 2, wherein
the master AC trunk line has:
multiple connection cables, each connection cable having:
an outer sheath; and
multiple electrical wires wrapped around by the outer sheath and mounted through the outer sheath in a longitudinal direction; and
multiple parallel connection nodes, each parallel connection node having multiple electrical couplers connected to the respective electrical wires of a corresponding connection cable; and
the multiple first electrical connection elements of the first connector of each connection device are electrically connected to the electrical couplers of the corresponding parallel connection node.

4. The parallel-connected solar power converter system as claimed in claim 3, wherein
the first connector includes a first isolation fastener mounted inside the first housing, wherein the first isolation fastener has multiple first channels through which the multiple first electrical connection elements are mounted;
the second connector includes a second isolation fastener mounted inside the second housing and having multiple second channels through which the multiple second electrical connection elements are mounted.

5. The parallel-connected solar power converter system as claimed in claim 4, wherein the multiple first electrical connection elements are metal tubings, the multiple second electrical connection elements are metal inserts, and the multiple electrical couplers are metal crimped joints.

6. The parallel-connected solar power converter system as claimed in claim 2, wherein
the first housing has two arms formed on a peripheral side wall of the first housing and oppositely located beside an opening formed through the peripheral side wall, wherein each arm has a barbed end; and
the second housing has:
two insertion holes aligned with the respective arms; and
two retaining blocks, each retaining block formed on an inner wall of a corresponding insertion hole.

7. The parallel-connected solar power converter system as claimed in claim 3, wherein
the first housing has two arms formed on a peripheral side wall of the first housing and oppositely located beside an opening formed through the peripheral side wall, wherein each an iii has a barbed end; and
the second housing has:
two insertion holes aligned with the respective arms; and
two retaining blocks, each retaining block formed on an inner wall of a corresponding insertion hole.

8. The parallel-connected solar power converter system as claimed in claim 4, wherein
the first housing has two arms formed on a peripheral side wall of the first housing and oppositely located beside an opening formed through the peripheral side wall, wherein each arm has a barbed end; and
the second housing has:
two insertion holes aligned with the respective arms; and
two retaining blocks, each retaining block formed on an inner wall of a corresponding insertion hole.

9. The parallel-connected solar power converter system as claimed in claim 5, wherein
the first housing has two arms formed on a peripheral side wall of the first housing and oppositely located beside an opening formed through the peripheral side wall, wherein each arm has a barbed end; and
the second housing has:
two insertion holes aligned with the respective arms; and
two retaining blocks, each retaining block formed on an inner wall of a corresponding insertion hole.
